(19) United States
(12) Patent Application Publication
(10) Pub. No.: US 2014/0250657 A1
(43) Pub. Date: Sep. 11, 2014

(54) INSTALLING COMPONENTS IN HOUSINGS

(71) Applicant: APPLE INC., CUPERTINO, CA (US)

(72) Inventors: CRAIG M. STANLEY, CAMPBELL, CA (US); DOUGLAS J. WEBER, ARCADIA, CA (US)

(73) Assignee: APPLE INC., CUPERTINO, CA (US)

(21) Appl. No.: 13/791,902

(22) Filed: Mar. 8, 2013

(51) Int. Cl. B29C 65/00; B29C 65/48

(52) U.S. Cl. CPC B29C 66/005; B29C 65/48
USPC 29/426.2; 29/428

(57) ABSTRACT

In a first embodiment, a housing that includes at least one aperture and a cavity. At least one component may be attached to at least one attachment structure and inserted into the cavity. A force may be exerted on the component that is sufficient to detach the component from the attachment structure and move the component at least partially into the aperture. In a second embodiment, a housing may be provided that includes at least one aperture and a cavity. At least one component may be attached to at least one attachment structure. and inserted into the cavity. At least one expandable member may also be inserted into the cavity and expanded to move the component at least partially into the aperture.

### TECHNICAL FIELD

This disclosure relates generally to assembly of devices, and more specifically to installing components in housings.

### BACKGROUND

Assembly of many different kinds of devices may include inserting components of a device into one or more apertures in a housing of the device. Such components may include microphones, cameras, displays, buttons, lights, sensors, speakers, ports, windows, cover glasses, and/or other device components. Often, such components may be installed by pressing the components into the respective apertures. The components may then be attached and/or sealed in place.

However, installation of such components may be performed from within a cavity of the housing. In some situations, the cavity may be a constricted enough space that sufficient room is not available in order to press the components into place. This may particularly be the case when the component is part of an array of components.

### SUMMARY

The present disclosure discloses systems and methods for installing components in housings. In a first embodiment, a housing includes at least one aperture and a cavity. At least one component may be attached to at least one attachment structure and inserted into the cavity. A force may be exerted on the component that is sufficient to detach the component from the attachment structure and move the component at least partially into the aperture.

In one or more implementations, the exertion of the force may be caused by one or more of: spinning the attachment structure, the component, and/or the housing; applying a vacuum to the component; and/or applying a magnetic force to the component. In various implementations, the component may be aligned with the aperture and/or attached to the aperture. The aperture may also be sealed around the component.

In a second embodiment, a housing may be provided that includes at least one aperture and at least one cavity. At least one component may be attached to at least one attachment structure. and inserted into the cavity. At least one expandable member may also be inserted into the cavity and expanded to move the component at least partially into the aperture.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1A is a front plan view of an example housing.

FIG. 1B is a top plan, cross-sectional view of the housing of FIG. 1A taken along line 1A of FIG. 1A.

FIG. 1C illustrates the housing of FIG. 1B after an attachment structure with an attached component is inserted into a cavity of the housing.

FIG. 1D illustrates the housing of FIG. 1C after a force is exerted on the component sufficient to break the attachment to the attachment structure and pull the component into an aperture of the housing.

FIG. 1E is a front plan view of an assembled device after components have been inserted into the apertures of the housing of FIG. 1A.

FIG. 2A illustrates a close up front plan view of an aperture of the housing of FIG. 1A in accordance with one or more embodiments of the present disclosure.

FIG. 2B illustrates a close up front plan view of the component of FIG. 1C in accordance with one or more embodiments of the present disclosure.

FIG. 3A illustrates the housing of FIG. 1C, when the aperture includes an o-ring.

FIG. 3B illustrates the housing of FIG. 3A after a force is exerted on the component sufficient to break the attachment to the attachment structure and pull the component into the aperture of the housing.

FIG. 4A illustrates the housing of FIG. 1C wherein a snap structure is attached to an inner portion of the aperture.

FIG. 4B illustrates the housing of FIG. 4A after a force is exerted on the component sufficient to break the attachment to the attachment structure and pull the component into the aperture of the housing.

FIG. 5A illustrates the housing of FIG. 1D wherein the component is sealed in the aperture with adhesive.

FIG. 5B illustrates the housing of FIG. 1B wherein adhesive dispensing mechanisms are mounted on an inner portion of the aperture.

FIG. 6A is a top plan view illustrating a collapsed balloon and a component attached to an attachment structure and inserted into a housing.

FIG. 6B illustrates inflation of the balloon and forcing of the component into an aperture of the housing.

FIG. 7 is a method diagram illustrating a method for installing components in housings. The method may assemble a device such as the assembled device of FIG. 1E.

### DETAILED DESCRIPTION

The description that follows includes sample systems and methods that embody various elements of the present disclosure. However, it should be understood that the described disclosure may be practiced in a variety of forms in addition to those described herein.

The present disclosure discloses systems and methods for installing components in housings. In a first embodiment, a housing may be provided. As one example, the housing may be a housing for an electronic device, such as a computer, tablet computing device, phone, wearable item (e.g., a watch, activity monitor and the like), speaker, and so on. The housing may include at least one aperture and at least one cavity. At least one component may be attached to at least one attachment structure. The attachment structure may be inserted into the cavity. A force may be exerted on the component that is sufficient to detach the component from the attachment structure. The exertion of the force may also move the component at least partially into the aperture.

In one or more implementations, the exertion of the force may include spinning the attachment structure, the component, and/or the housing. In other implementations, the exertion of the force may include applying a vacuum to the component. In still other implementations, the exertion of the force may include applying a magnetic force to the component.

In various implementations, the component may be aligned with the aperture. In some implementations, the component may be attached to the aperture (such as by adhesives or other attachment mechanisms). The aperture may also be sealed around the component.

In a second embodiment, a housing may be provided. The housing may include at least one aperture and a cavity. At least one component may be attached to at least one attachment structure. The attachment structure may be inserted into the cavity. At least one expandable member, such as a balloon, may also be inserted into the cavity. The component may be moved at least partially into the aperture by expanding the expandable member.

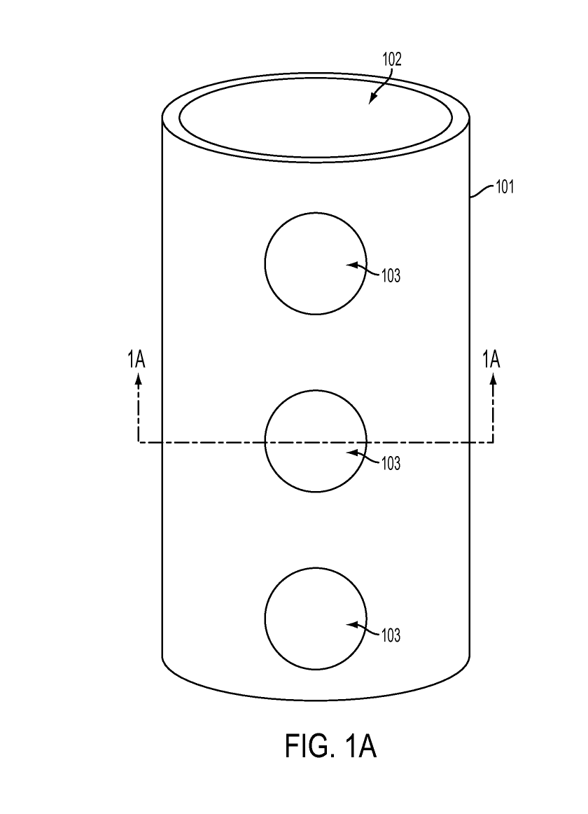

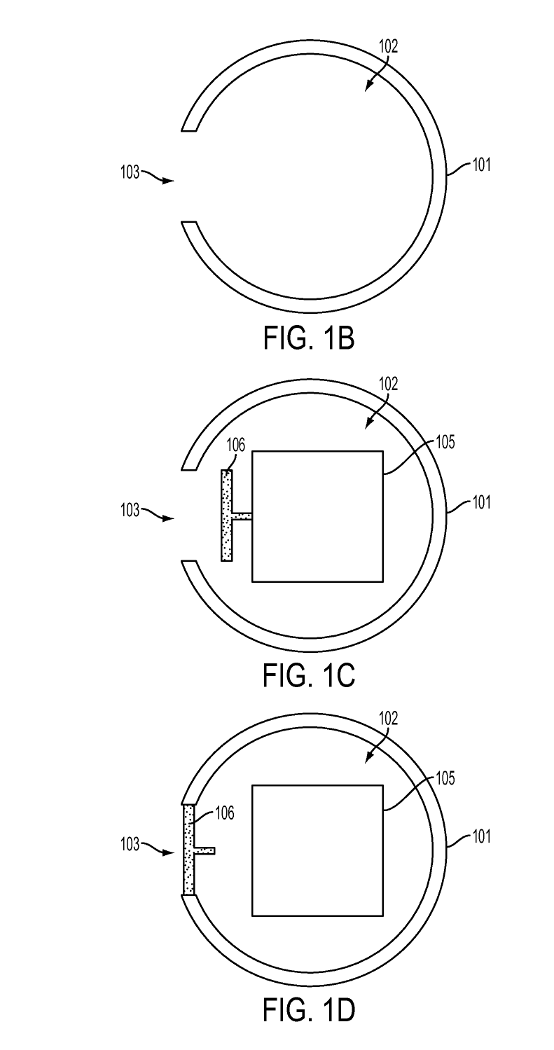

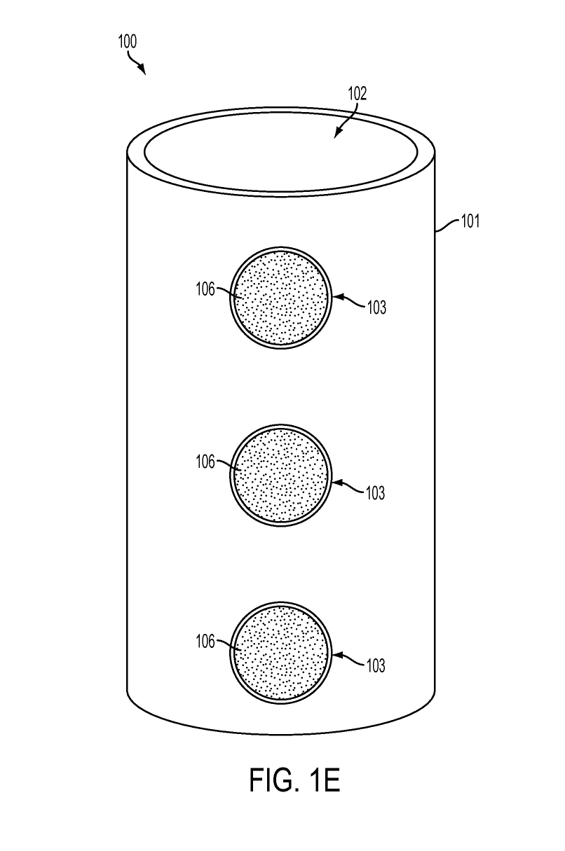

FIGS. 1A-1E illustrate installation of at least one component 106 in a housing 101 as part of assembling a device 100. The component 106 is illustrated in FIGS. 1A-1E as a generic component. However, it is understood that this is an example. In various implementations, the component may be any kind of component of the device such as one or more microphones, cameras, displays, buttons, lights, sensors, speakers, ports, windows, cover glasses, and/or other device components.

FIG. 1A is a front plan view of a housing 101. As illustrated, the housing includes a cavity 102 and one or more apertures 103. Though the housing is illustrated as having a tube shape, it is understood that this is for the purposes of example. In various implementations, the housing may have a variety of different shapes such as rectangular and so on. Further, though the housing is illustrated as having three apertures aligned on a single surface of the housing, it is understood that this is for the purposes of example. In various implementations, the housing may include any number of apertures (which may or may not fully extend between the cavity and an outside of the housing) located anywhere on the housing without departing from the scope of the present disclosure.

FIG. 1B is a top plan cross sectional view of the housing 101 of FIG. 1A taken along line 1A of FIG. 1A. As illustrated in FIG. 1C, one or more components 106 may be attached to one or more attachment structures 105 and the one or more attachment structures may be inserted into the cavity 102 of the housing. FIG. 1C illustrates FIG. 1B after the attachment structure with the attached component is inserted into the cavity. Although the attachment structure is illustrated as a single rectangular shaped member, it is understood that this is for the purposes of example. In various implementations, any number of components may be attached to any number of attachment structures, which may be any kind of structure that may be utilized for inserting the components into the cavity, without departing from the scope of the present disclosure.

The component 106 may be attached to the attachment structure 105 by a variety of different mechanisms. In some cases, the component and the attachment structure may be magnetic (and/or include one or more magnetic elements) and the component may be attached to the attachment structure magnetically. In other cases, the component may be adhesively attached to the attachment structure utilizing one or more different adhesives. In still other cases, the component may be mechanically attached to the attachment structure utilizing one or more mechanical attaching elements (such as one or more snaps, clips, wires, braces, and so on).

In some cases, the component 106 may be aligned with a respective aperture 103 after the attachment structure 105 has been inserted into the cavity 102. Such alignment may be performed by manipulating the attachment structure, thereby manipulating the position and/or location of the component.

A force may be exerted on the component 106. The force exerted on the component may be sufficient to overcome the attachment of the component to the attachment structure 105, thereby detaching the component from the attachment structure. The exerted force may also pull and/or otherwise move the component partially and/or fully into the aperture 103, as illustrated in FIG. 1D. Thereafter, in some cases, the attachment structure may be removed from the cavity 102.

In various implementations, the force exerted on the component 106 may be a variety of different kinds of force. By way of a first example, in some implementations the force may be a centrifugal force. In such examples, the attachment structure 105 (and/or the component and/or the housing 101) may be spun and/or otherwise rotated. As a result, centrifugal force may detach the component from the attachment structure and/or move the component fully and/or partially into the aperture 103.

By way of a second example, in some implementations the force may be a magnetic force. In such examples, an electromagnet and/or other magnetic element may be applied (such as from outside the housing 101). The component 106 may be magnetic and/or include a magnetic element. As a result, magnetic force may detach the component from the attachment structure 105 and/or move the component fully and/or partially into the aperture 103.

By way of a third example, in some implementations the force may be a vacuum force. In such examples, a vacuum may be applied to the component 106. As a result, vacuum force may detach the component from the attachment structure 105 and/or move the component fully and/or partially into the aperture 103.

Although the above examples of force discuss centrifugal force, magnetic force, and vacuum force, it is understood that these are examples. Other forces, and/or a combination of forces, may be utilized without departing from the scope of the present disclosure.

As described above, the component 106 may be fully and/or partially moved into the aperture 103 as a result of the force. In some cases, the component may be fully moved into the aperture such that the component is fully contained within the aperture. In other cases, the component may be moved into the aperture such that only a part of the component is contained within the aperture and/or such that only a part of the aperture contains all or a part of the component.

For example, the component and/or the aperture may be configured such that the component is only able to move partway into the aperture (such as where part of the aperture is wide enough to admit the component but part of the aperture is narrower than the component and the component is only able to be moved partway into the aperture). By way of another example, the force exerted on the component to move the component into the aperture may be applied for a duration sufficient to move the component partway into the aperture but not for a sufficient enough duration that the component is moved fully into the aperture.

In some cases, the component 106 may be attached to the aperture 103 after the component is moved into the aperture. Such attachment may be accomplished utilizing one or more adhesives; one or more attachment members of the component, the aperture, and/or the housing; and so on. In various cases, the attachment may seal the aperture around the component and/or otherwise seal the aperture and/or component. Such a seal may be a hermetic seal, and air seal, and/or other kind of seal.

FIG. 1E is a front plan view of an assembled device 100 after the force has been exerted and components 106 have been inserted into the apertures 103 of the housing 101 of FIG. 1A. As illustrated by FIGS. 1A-1E, the components are installed into the assembled device 100 even though the cavity 102 may be too constricted to allow pressing of the components into place.

In one or more implementations, the component 106 may include and/or otherwise be coupled to one or more force magnifying elements that increase the effectiveness of the force exerted on the component. For example, in cases where centrifugal force is applied to the component, the component may be attached to one or more weights (such as one or more weights positioned in between the component and the attachment structure). This weight may increase the force exerted on the component when the centrifugal force is applied. Such weight may or may not be removed after the force has been applied.

By way of another example, in cases where magnetic force is applied to the component, the component may be attached to one or more magnets (such as one or more magnets positioned in between the component and the attachment structure). This magnet may increase the force exerted on the component when the magnetic force is applied. Such magnet may or may not be removed after the force has been applied.

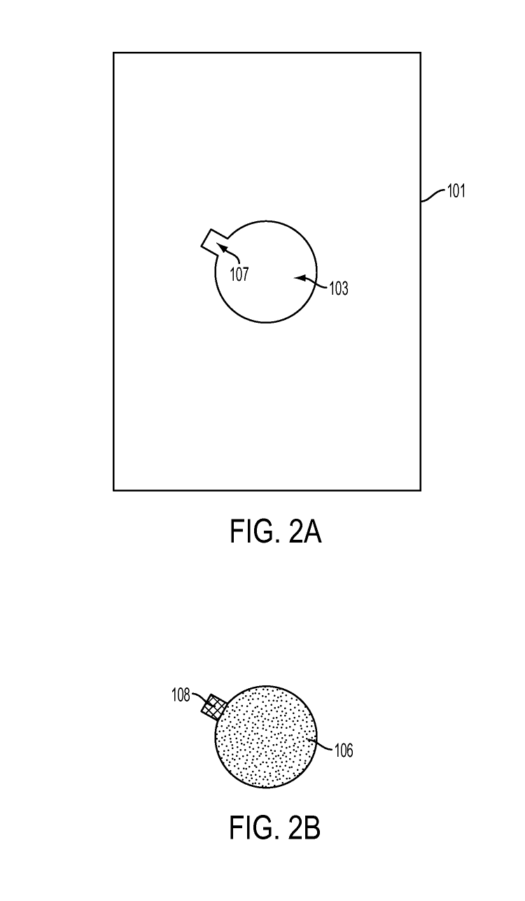

As discussed above, in some cases the component 106 may be aligned with a respective aperture 103 after the attachment structure 105 has been inserted into the cavity 102. Such alignment may be performed by manipulating the component 106, the attachment structure 105, and/or the housing 101 and/or may involve interaction of one or more lead in structures of the aperture and/or the housing and/or one or more mechanical keys of the component. For example, FIG. 2A illustrates a close up front plan view of an aperture 103 of the housing 101 of FIG. 1A and FIG. 2B illustrates a close up front plan view of the component 106 of FIG. 10 in accordance with one or more embodiments of the present disclosure.

The aperture 103 (as illustrated in FIG. 2A) may include one or more lead in structures 107 and the component 106 (as illustrated in FIG. 2B) may include one or more mechanical keys 108. As can be seen by comparing FIGS. 2A and 2B, the mechanical key may be matched up with the lead in structure when the component is aligned with the aperture, guiding correct alignment and/or preventing incorrect alignment.

As discussed above, in some cases, the component 106 may be attached to the aperture 103 after the component is moved into the aperture. Such attachment may be accomplished utilizing one or more attachment members of the component, the aperture, and/or the housing. Such attachment members may include any kind of device utilized to attach, such as one or more snaps, magnets, flaps, o-rings, gaskets, and so on.

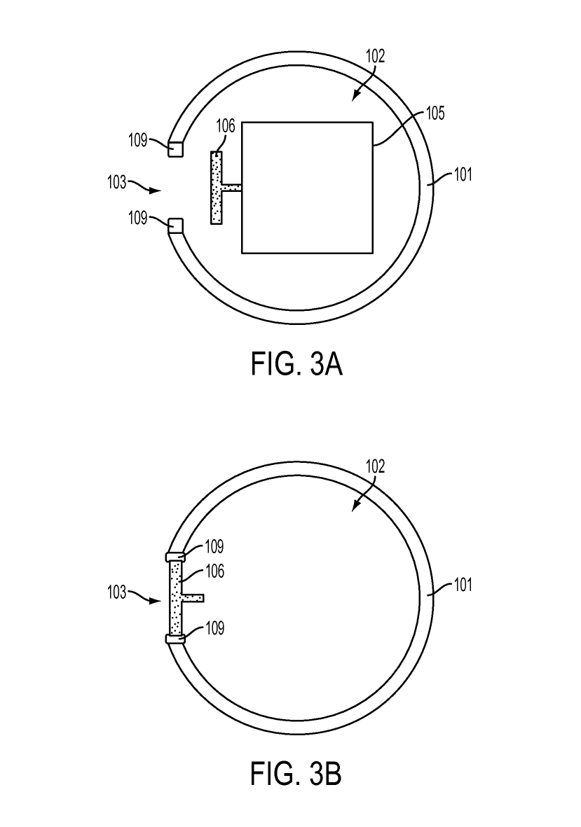

For example, FIG. 3A illustrates the housing 101 wherein the aperture 103 includes an attachment member 109. As illustrated, the attachment member 109 is an o-ring. However, this is understood to be for the purposes of example. In some cases, the attachment member 109 may be any kind of elastic and/or rubber gasket and/or similar component.

FIG. 3B illustrates FIG. 3A after a force is exerted on the component 106 sufficient to break the attachment to the attachment structure and pull the component at least partially into the aperture 103. As the attachment member 109 is elastic and sized slightly smaller than the component, the attachment member resists the insertion of the component and then, after the component is inserted, retrains the component from being withdrawn from the aperture. This can be seen in FIG. 3B by the way that the attachment member 109 swells around the inserted component 106.

It should be understood that the attachment member 109 is an example. Attachment members other than o-rings, gaskets, and the like may be utilized in various implementations and may be attached to structures other than the aperture 103 (such as the component 106) without departing from the scope of the present disclosure.

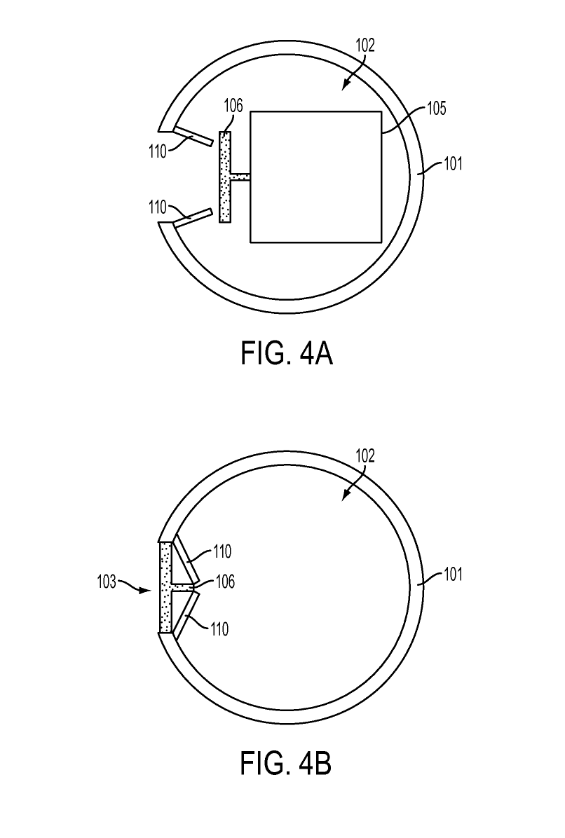

By way of another example, FIG. 4A illustrates the housing 101 wherein the aperture 103 includes an attachment member 110. As illustrated, the attachment member 110 is a pair of flaps. However, this is understood to be for the purposes of example. In some cases, the attachment member 110 may be any number of flaps and/or similar structures. FIG. 4B illustrates FIG. 4A after a force is exerted on the component 106 sufficient to break the attachment to the attachment structure and pull the component at least partially into the aperture 103.

As can be seen from FIG. 4A, the attachment member 110 may be configured to present a smaller opening than the component 106 prior to insertion. As the force is exerted and the component contacts the attachment member 110, the component may push open the attachment member 110. After the component passes through the attachment member 110, the attachment member 110 may return to its original position, thus restraining the component as can be seen in FIG. 4B.

It should be understood that the attachment member 110 is an example. Attachment members other than flaps and the like may be utilized in various implementations and may be attached to structures other than the aperture 103 (such as the component 106) without departing from the scope of the present disclosure.

As discussed above, in some cases attachment of the component 106 to the aperture 103 may be accomplished utilizing one or more adhesives. Such adhesive may be any kind of adhesive, such as pressure sensitive adhesive, adhesive that requires multiple days for curing, polymer-based adhesives, and so on. If adhesive is utilized to attach the component to the aperture, the adhesive may also be cured.

In cases where adhesive is utilized to attach the component 106 to the aperture 103, the adhesive may be applied in a number of different ways to a number of different locations at a number of different times.

By way of a first example, adhesive may be applied to the aperture 103 before the force is exerted on the component 106. Such application of the adhesive may be made from outside the housing 101 and/or from within the cavity 102.

By way of a second example, adhesive may be applied during the exertion of the force on the component 106. The exertion of the force itself may apply the adhesive. In some cases, adhesive may be inserted into the cavity 102 prior to the exertion of the force and the exertion of the force may cause the adhesive inserted into the cavity to be applied to the aperture 103 and/or the component. In such cases, the exertion of the force may pull the adhesive toward the aperture and/or the component.

For example, the housing 101 may include one or more air holes and/or ventilation holes (not shown) such that in cases where the force is centrifugal force, air is sucked into the air holes and/or ventilation holes and out the aperture via the cavity, thus pulling the adhesive toward the aperture.

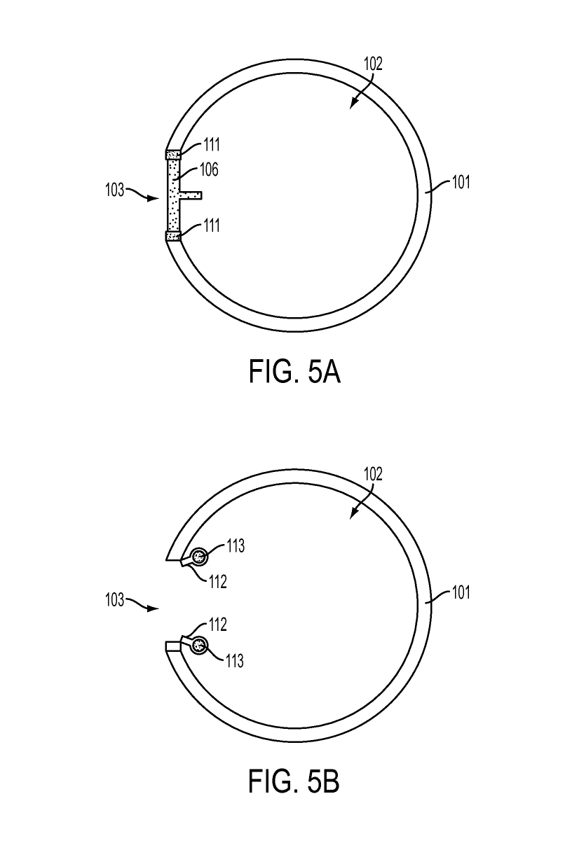

FIG. 5A illustrates the component 106 after exertion of the force inserted into at least partially into the aperture 103 where the aperture around the component is sealed with adhesive 111.

Although the adhesive is shown as positioned between the component and the aperture, it is understood that this is for the purposes of example. In various implementations, the adhesive may be positioned differently without departing from the scope of the present disclosure. For example, in various implementations the adhesive may cover the surface of the component 106 that faces the cavity 102 in addition to being positioned between the component and the aperture 103. In such implementations, the component may be covered by one or more adhesive shields, such as paper or tape, which protect the component from being contaminated by the adhesive.

In other cases, the adhesive may be stored in one or more adhesive dispensers (such as tubes, bottles, and/or other adhesive containers operable to dispense adhesive) mounted on the component 106, the aperture 103, the housing 101, and so on. Exertion of the force may cause the adhesive dispensers to dispense the adhesive.

For example, FIG. 5B illustrates the housing 101 as including adhesive dispensers 112 that store adhesive 113 mounted on the aperture 103. The adhesive may be kept in place in the adhesive dispensers prior to the exertion of the force by a variety of different mechanisms, such as a membrane covering an opening of the adhesive dispensers that is broken by the exertion of the force, capillary pressure that is overcome by the exertion of the force, hydrogen bonds that are overcome by the exertion of the force, and so on. Exertion of the force may cause the adhesive to be pulled from the adhesive dispensers and/or otherwise dispensed toward the aperture 103, the component 106, and/or the housing 101.

In this example, the exertion of the force may pull the adhesive toward the aperture and/or the component. In some cases, the housing 101 may include one or more air holes and/or ventilation holes (not shown) such that in cases where the force is centrifugal force, air is sucked into the air holes and/or ventilation holes and out the aperture via the cavity, thus pulling the adhesive toward the aperture.

FIG. 5B illustrates the adhesive dispensers 112 as a pair of bottles mounted on the aperture 103. However, it is understood that the implementation depicted Is but one of many configurations that may be used in various embodiments. In various implementations, any number of adhesive dispensers of any type (such as tubes and/or other kinds of containers) may be mounted to any structure (such as the component 106, the housing 101, and/or the attachment structure 105) without departing from the scope of the present disclosure.

Additionally, the component 106 may be a type of component that requires connection (such as electrical connection) to one or more other components and/or other portions of the assembled device 100. In some cases, the component may be connected prior to attachment to the attachment structure 105 and/or insertion into the cavity 102.

However, in other cases the component may be connected after attachment to the attachment structure 105 and/or insertion into the cavity 102, before and/or after exertion of the force, before and/or alignment with the aperture 103, before and/or after attachment to the aperture, before and/or after sealing of the aperture, before and/or after curing of any utilized adhesive, before and/or after insertion into the aperture, and so on. Such connection may be performed utilizing any number of different connection systems such as wires, circuit boards, and so on.

Although the above describes installation of a single component, it is understood that this is for the purposes of example. The above discussed process may install multiple components (such as an array of components, an array of related components, and/or an array of components of the same type) without departing from the scope of the present disclosure. Additionally, though the above is described with respect to a single exertion of force, multiple different forces may be exerted at different times in order to install multiple different components (or a single component that is installed utilizing the exertion of different forces) without departing from the scope of the present disclosure.

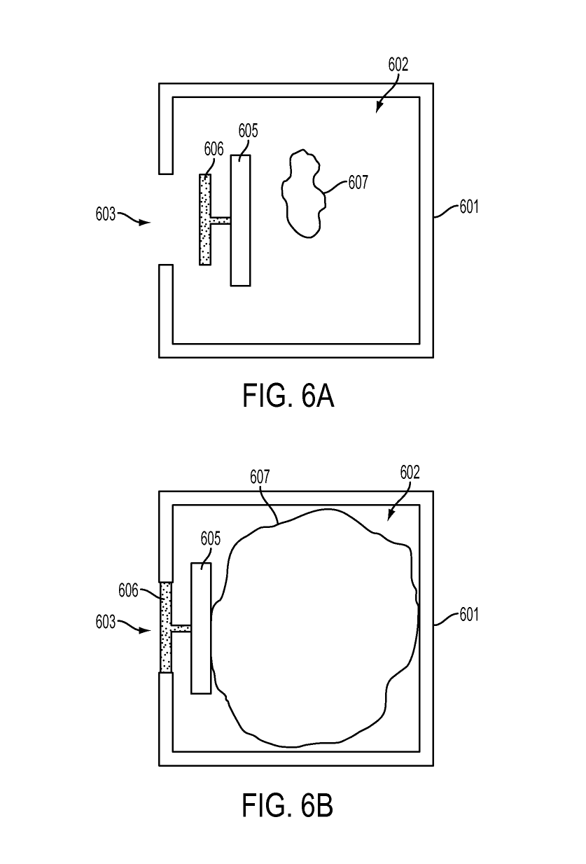

FIGS. 6A-6B illustrate installation of at least one component 606 in a housing 601 as part of assembling a device in accordance with an alternative embodiment of the present disclosure.

As illustrated, the housing 601 includes a cavity 602 and one or more apertures 603. Though the housing is illustrated as having a rectangular shape, it is understood that this is for the purposes of example. In various implementations, the housing may have a variety of different shapes.

As illustrated in FIG. 6A, at least one component 606 may be attached to at least one attachment structure 605 and inserted into the cavity 602 of the housing 601. A expansion member 607 that is operable to expand and/or contract (such as a balloon) is also inserted into the cavity while contracted.

The expansion member 607 may then be expanded, as shown in FIG. 6B. As illustrated in FIG. 6B, expansion of the expansion member may press on the attachment structure 605, which may cause the component 606 to be inserted partially or fully into the aperture 603.

In some cases, the expansion of the expansion member 607 may also detach the component 606 from the attachment structure 605. Subsequently, the expansion member and/or the attachment structure may be removed from the cavity 602.

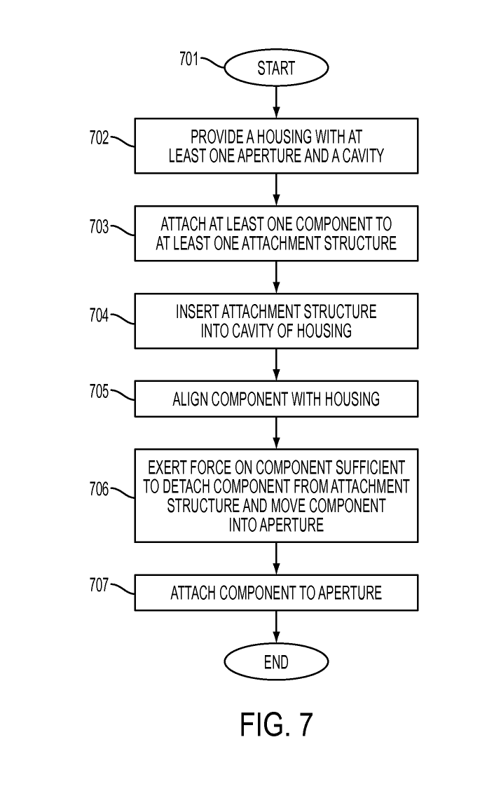

FIG. 7 illustrates a method 700 for installing components in housings. In some implementations, the method 700 may assemble a device such as the assembled device 101 of FIG. 1E.

The flow begins at block 701 and proceeds to block 702 where a housing with at least one aperture and a cavity is provided. The flow then proceeds to block 703 where at least one component is attached to at least one attachment structure. The flow then proceeds to block 704 where the attachment structure is inserted into the cavity before the flow proceeds to block 705 where the component is aligned with the aperture.

Next, the flow proceeds to block 706 where force is exerted on the component sufficient to detach the component from the attachment structure and move the component into the aperture. The flow then proceeds to block 707 where the component is attached to the aperture.

Finally, the flow proceeds to block 708 and ends.

In the present disclosure, the methods disclosed may be implemented as sets of instructions or software readable by a device that controls machinery and/or other components for performing the operations. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) that is operable to control machinery machinery and/or other components to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

We claim:

1. A method for installing at least one component in a housing, the method comprising:
providing a housing having a sidewall and an aperture defined in the sidewall, the sidewall at least partially defining a cavity;
attaching at least one component to at least one attachment structure;
inserting the at least one attachment structure into the cavity; and
exerting force on the at least one component sufficient to detach the at least one component from the at least one attachment structure and move the at least one component at least partially into the at least one aperture.

2. The method of claim 1, wherein said operation of exerting force comprises at least one of:
spinning at least the at least one attachment structure;
applying a vacuum to the at least one component; or
applying a magnetic force to the at least one component.

3. The method of claim 1, further comprising:
aligning the at least one component with the at least one aperture.

4. The method of claim 3, wherein said operation of aligning the at least one component comprises:
aligning a lead in structure of the at least one aperture with at least one mechanical key of the at least one component.

5. The method of claim 1, further comprising:
attaching the at least one component to the at least one aperture.

6. The method of claim 5, wherein said operation of attaching the at least one component to the at least one aperture is performed at least utilizing adhesive.

7. The method of claim 6, wherein the adhesive is applied to the at least one aperture.

8. The method of claim 7, wherein the adhesive is applied to the at least one aperture prior to said operation of exerting force.

9. The method of claim 6, wherein the adhesive is applied during said operation of exerting force.

10. The method of claim 9, wherein the adhesive is applied by said operation of exerting force.

11. The method of claim 10, wherein the adhesive is stored in at least one adhesive dispenser mounted on at least one of the at least one component or an inner portion of the at least one aperture.

12. The method of claim 10, wherein the adhesive is kept in place in at least one adhesive dispenser prior to said operation of exerting force and said operation of exerting force moves the adhesive out of the at least one adhesive dispenser.

13. The method of claim 9, wherein said operation of exerting force pulls the adhesive toward the at least one aperture.

14. The method of claim 6, wherein adhesive is inserted into the cavity prior to said operation of exerting force.

15. The method of claim 5, wherein said operation of attaching the at least one component to the at least one aperture is performed at least utilizing at least one attachment member of the at least one aperture.

16. The method of claim 15, wherein the at least one attachment member resists insertion of the at least one component during said operation of insertion and restrains the at least one component after said operation of insertion.

17. The method of claim 5, wherein said operation of attaching the at least one component further comprises:
sealing the at least one aperture around the at least one component.

18. The method of claim 1, wherein said operation of attaching at least one component to at least one attachment structure further comprises at least one of:
magnetically attaching the at least one component to the at least one attachment structure;
mechanically attaching the at least one component to the at least one attachment structure; or
adhesively attaching the at least one component to the at least one attachment structure.

19. The method of claim 1, wherein the at least one component comprises at least one of at least one microphone, camera, display, cover glass, button, speaker, sensor, or light.

20. A method for installing at least one component in a housing, the method comprising:
providing a housing that includes at least one aperture and a cavity;
attaching at least one component to at least one attachment structure;
inserting the at least one attachment structure into the cavity;
inserting at least one expandable member into the cavity; and
moving the at least one component at least partially into the at least one aperture by expanding the at least one expandable member.
